(19) United States
(12) Patent Application Publication
(10) Pub. No.: US 2015/0035243 A1
(43) Pub. Date: Feb. 5, 2015

(54) DEVICE FOR TRANSPORTING BACK RAILS

(71) Applicant: James Everard Carter, Harker Heights, TX (US)

(72) Inventor: James Everard Carter, Harker Heights, TX (US)

(21) Appl. No.: 13/955,150

(22) Filed: Jul. 31, 2013

(51) Int. Cl. B62B 1/26

(52) U.S. Cl. CPC B62B 1/26
USPC 280/30

(57) ABSTRACT

Certain embodiments are directed to a device configured for transporting riser railings.

### BACKGROUND

Back rails of choral risers are bulky and challenging to move efficiently. Currently available devices for transporting such items require a moving truck. There is a need for additional devices for transporting choral riser associated structures without needing a moving truck.

### SUMMARY

Certain embodiments are directed to a device for transporting back rails and the like. In certain aspect the device is a platform for transporting railings. The platform comprises (a) a platform base having a top and bottom surface, the platform base being configurable to fit a preexisting cart; (b) two vertical supports operatively coupled the top surface of the platform with the long axis of the vertical supports positioned perpendicular to the plane of the platform; and (c) horizontal supports operatively coupled to the vertical supports configured to support back rails; wherein the platform base, vertical supports, and horizontal supports can be disassembled when not needed and assembled when needed. In certain embodiments the platform is configured to fit in a low profile trailer (i.e., an enclosed trailer with an interior height of about 4, 5, 6, or 7 feet, including all values and ranges there between) when placed on a preexisting cart. The platform can comprise a sub-platform on the bottom surface of the platform configured to have an opening to receive a cart handle when the handle is not in use. This sub-platform is configured to distribute the load to the appropriate components of the cart.

The platform can comprise one or more stabilizers configured to interact with the cart to prevent skewing of the platform in relation to the cart, that is limiting horizontal and lateral movement of the platform in relation to the cart. In certain aspects the height of the platform as measured from the bottom the platform to the top of a vertical support is at most 38 inches. In a further aspect the platform is operatively attached to a cart, e.g., positioned such that the platform sits on top of the cart and is stabilized via the stabilizers. In certain aspects the height as measured from the bottom of a wheel of the wheeled cart to the top of a vertical support is at most 42, 43, 44, 45, or 45.5 inches. In certain aspects the height is adjustable so that the platform and rails can be transported in the cargo bin of a commercial bus. The platform provides a compact device that can be transported using trailers or vehicle compartments with height limitations.

Other embodiments of the invention are discussed throughout this application. Any embodiment discussed with respect to one aspect of the invention applies to other aspects of the invention as well and vice versa. Each embodiment described herein is understood to be embodiments of the invention that are applicable to all aspects of the invention. It is contemplated that any embodiment discussed herein can be implemented with respect to any method or composition of the invention, and vice versa. Furthermore, compositions and kits of the invention can be used to achieve methods of the invention.

The use of the word “a” or “an” when used in conjunction with the term “comprising” in the claims and/or the specification may mean “one,” but it is also consistent with the meaning of “one or more,” “at least one,” and “one or more than one.”

Throughout this application, the term “about” is used to indicate that a value includes the standard deviation of error for the device or method being employed to determine the value.

The use of the term “or” in the claims is used to mean “and/or” unless explicitly indicated to refer to alternatives only or the alternatives are mutually exclusive, although the disclosure supports a definition that refers to only alternatives and “and/or.”

As used in this specification and claim(s), the words “comprising” (and any form of comprising, such as “comprise” and “comprises”), “having” (and any form of having, such as “have” and “has”), “including” (and any form of including, such as “includes” and “include”) or “containing” (and any form of containing, such as “contains” and “contain”) are inclusive or open-ended and do not exclude additional, unrecited elements or method steps.

Other objects, features and advantages of the present invention will become apparent from the following detailed description. It should be understood, however, that the detailed description and the specific examples, while indicating specific embodiments of the invention, are given by way of illustration only, since various changes and modifications within the spirit and scope of the invention will become apparent to those skilled in the art from this detailed description.

### DESCRIPTION OF THE DRAWINGS

The following drawings form part of the present specification and are included to further demonstrate certain aspects of the present invention. The invention may be better understood by reference to one or more of these drawings in combination with the detailed description of the specification embodiments presented herein.

FIG. 1. Illustrates a side view of one embodiment of a transport device for back rails.

FIG. 2. Illustrates a top view of the device depicted in FIG. 1.

FIG. 3. Illustrates a bottom view of the device depicted in FIG. 1.

FIG. 4. Illustrates a cross section A-A of FIG. 1.

### DESCRIPTION

Certain embodiments are directed to platform configured to support and/transport riser railings. In certain aspects the platform comprises a platform base, two vertical supports, and railing supports. The platform base can further comprise stabilizers. In certain aspects a stabilizer is configured to accommodate a portion of a preexisting cart that is folded and not in use while using the platform/cart combination to store or move riser railings. In a further aspect, a second stabilizer can be configured to maintain orientation of the platform in relation to the cart. One example is configuring anti-skew attachments to the platform to reduce lateral sliding of the platform relative to the long or short axis of the plane of the platform. One example of a cart to be used with the platform is a Rock-N-Roller® Multi-Cart® model R-14 and the like.

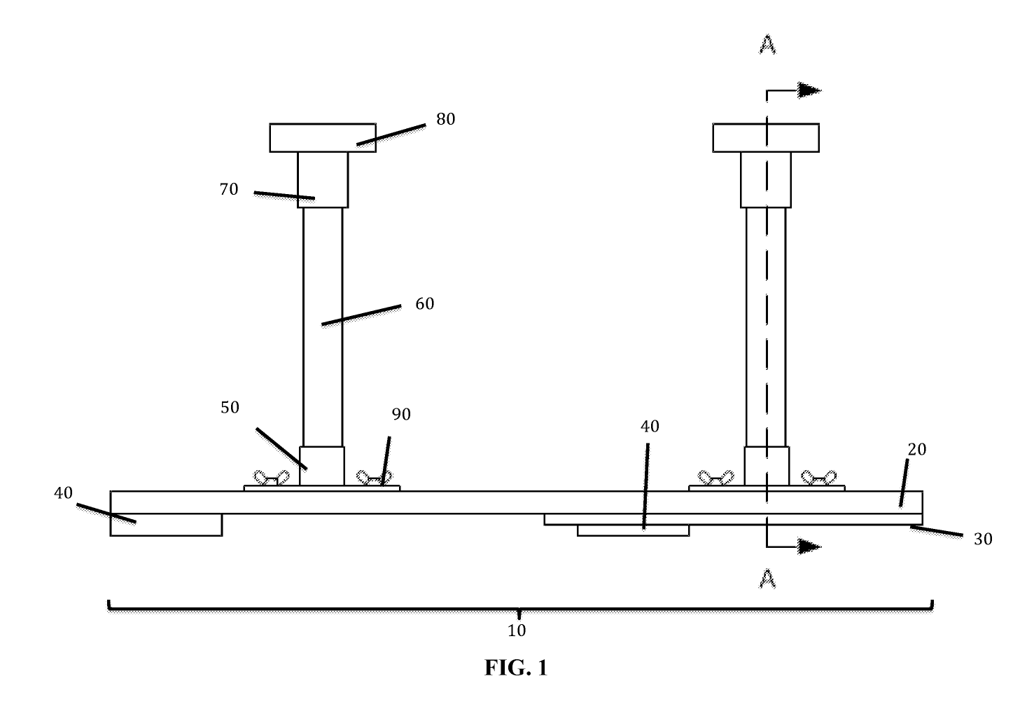

One example of such a platform is illustrated in FIG. 1. FIG. 1 shows a side view of platform 10 with base 20 coupled to vertical supports 60 and stabilizers 30 and 40. The proximal end of vertical support 60 is coupled to the platform by support base 50 and attached, for example, using bolt and wing-nut 90. Other types of attachments are known in the art and one of skill can readily adapt attachments to secure support base 50 to base 20. The distal end of vertical support 60 is coupled to railing support 80. Railing support 80 is coupled to vertical support 60 by support adapter 70. In certain aspects vertical support 60 is secured to support base 50 and support adapter 70 by a pin inserted in a hole(s) formed in support base 50 and/or support adapter 70, and aligned with a hole formed in vertical support 60. In certain aspects a pin is retractably attached to the vertical support and is positioned to align with a hole in support base 50 or support adapter 70. In other aspects the pin can traverse the diameter of the base support 50 and vertical support 60 and can be locked in position by using a cotter pin, a nut, or other securing mechanisms known in the art. Base 20 can be made from materials such as wood, pressboard, plastic, metal, or the like. In certain aspects the length of base 20 is dictated by the dimensions of the railings to be stored or transported by the platform. In certain aspects platform base 20 is at most, at least, or about 3, 3½, 4, 4½, 5, 5½, or 6 feet in length, including all lengths and ranges there between; and is at most, at least, or about 12, 14, 16, 18, 20, 22, 24, or 26 inches wide, including all widths and ranges there between; and at most, at least, or about ¼, ½, ¾, 1, 1½, or 2 inches thick, including all thicknesses and ranges there between. In certain aspects the height from the bottom of platform base 20 to the top of vertical support 60 is about 35, 36, 37, 38, 39, or 40 inches. In a further embodiment the height is about 37½ inches. The height of the assembled platform is selected based on the height of the doorway on a cargo trailer used to transport a loaded cart or the doorway height of a storage space in which the loaded cart is to be stored.

In certain embodiments the platform is configured to be transported or stored in a trailer or storage space having a doorway height of at most, about, or less than 60, 54, 48, or 42 inches including all values and ranges there between.

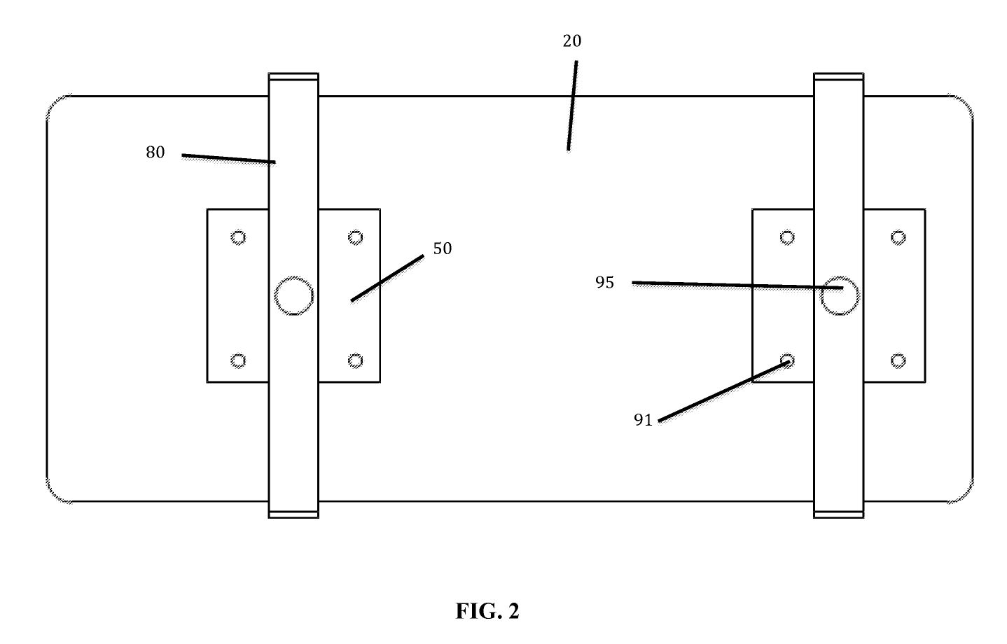

FIG. 2 illustrates a top view of the embodiment depicted in FIG. 1. FIG. 2 illustrates a top view showing the top surface of platform base 20. Support base 50 is shown that forms holes used for attaching support base 50 to platform base 20. Vertical support cap 95 is shown as well as railing support 80. Railing support 80 forms an upturned stop at each end so that rails positioned on the top of rail support 80 will not slide off the rail support 80. Rail support 80 can be at most, at least, or about 14, 16, 18, 20, 22, 24, 26, for 28 inches long, including all lengths and ranges there between.

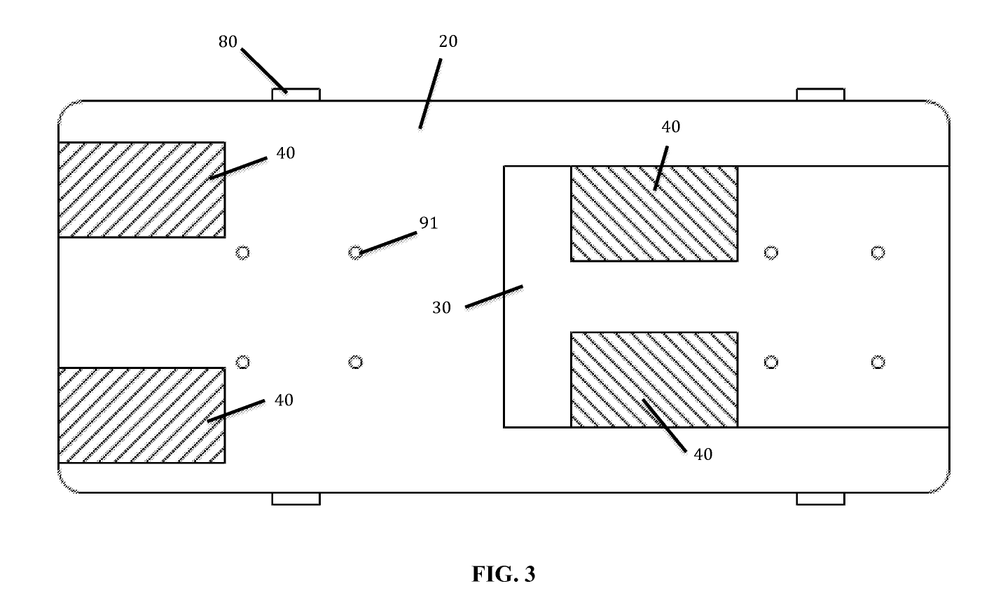

FIG. 3 illustrates a bottom view of the embodiment depicted in FIG. 1. The bottom surface of the platform base is configured to interact with the cart or apparatus on which the platform is to be placed. Various structures are included to secure the position of the platform on the cart or to distribute the weight of the platform the weight bearing components of an attached cart. One such structure is stabilizer 30 that is configured so that a handle or other folding portion of the cart that is not in use can be so positioned without destabilizing the interaction of platform base 20 with the cart and allowing distribution of weight to the cart frame. Anti-skew stabilizer 40 can be configured for positioning in the structure of the cart to provide resistance to lateral and horizontal movement of the platform in relation to the cart. In certain aspects the platform is configured to be lifted from the cart without the need to remove anchors or attachments. In certain aspects mechanical means to fix the platform to a cart are explicitly excluded. The weight of the railings and platform in conjunction with the design of the platform maintains a stable association between the cart and platform 10.

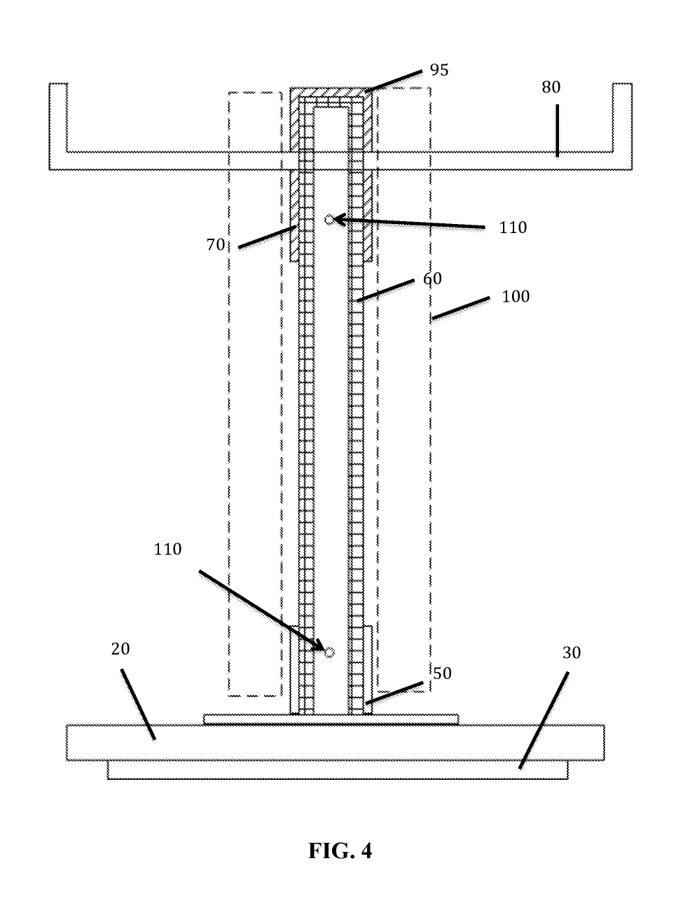

FIG. 4 illustrates the cross-section A-A of FIG. 1. The drawing depicts the support base 50 attached to the platform base 20. Vertical support 60 is operatively coupled to support base 50, railing support 80, railing support adapter 70, and cap 95. Hole 110 can be formed for using a pin or bolt to secure vertical support 60 to support base 50 and/or railing support adapter 70. An outline of railing 100 positioned on railing support 80 is depicted as a dashed line outline. In one aspect the railings can be railings of Wegner Tourmaster™ choral risers. In certain aspects vertical support 60 can be removed from support base 50 in order to store platform when not in use. In certain aspects the platform is configured to carry 6, 8, 10, 12 or more riser railings. In certain aspects railing support 80 is welded or otherwise permanently fixed to vertical support 60. In a further aspect the railing support 80 and vertical support assembly can be welded or permanently fixed to railing support adapter 70, cap 95 or both. In certain aspects vertical support 60 removeably connected to support base 50. In still a further aspect support base 50 and vertical support 60 are configured to be aligned so that railing support 80 is parallel with the short axis of platform 20. In certain aspects support base 50 and vertical support 60 form holes that can be aligned and secured by a pin or bolt. In certain embodiments railing support 80 can be configured with a cushioning material along the external surface to reduce damage or scratching of railings as they are transported. In certain aspects the cushioning is a rubber cushioning and can be in the form of a sleeve.

1. A platform for transporting back rails of choral risers comprising:
(a) a platform base having a top and bottom surface, the platform base being configurable to fit a preexisting cart;
(b) two vertical supports operatively coupled the top surface of the platform with the long axis of the vertical supports positioned perpendicular to the plane of the platform; and
(c) horizontal supports operatively coupled to the top of the vertical supports forming a T and configured to support hanging of the back rails on the horizontal supports; wherein the platform base, vertical supports, and horizontal supports can be disassembled when not needed and assembled when needed.

2. The device of claim 1, wherein the platform comprises a second platform on the bottom surface of the platform configured to have an opening to receive a cart handle that is used when transporting the choral risers.

3. The device of claim 1, wherein the platform comprises one or more stabilizers configured to interact with the cart to prevent skewing of the platform in relation to the cart when assembled.

4. The device of claim 1, wherein the height of the platform as measured from the bottom the platform to the top of a vertical support is at most 38 inches.

5. The device of claim 1 operatively attached to a wheeled cart.

6. The device of claim 5, wherein the height as measured from the bottom of a wheel of the wheeled cart to the top of a vertical support is at most 45.5 inches.
